(19) United States
(12) Patent Application Publication
(10) Pub. No.: US 2005/0270598 A1
(43) Pub. Date: Dec. 8, 2005

(54) System and method for reading color images

(75) Inventor: Sueo Ueno, Shizuoka-ken (JP)

Correspondence Address: FOLEY AND LARDNER;SUITE 500, 3000 K STREET NW, WASHINGTON, DC, 20007, US

(73) Assignee: KABUSHIKI KAISHA TOSHIBA and TOSHIBA TEC KABUSHIKI KAISHA

(21) Appl. No.: 10/849,841

(22) Filed: May 21, 2004

(51) Int. Cl. G06K 9/00

(52) U.S. Cl. 358/518; 358/509

(57) ABSTRACT

A scanner includes a light source that scans light on a surface to be read, and an optical system that reflects the light scanned on the surface. The optical system includes a first mirror that reflects the light reflected from the surface, at least one intermediate mirror that reflects the light reflected by the first mirror, and a second mirror that reflects the light reflected by the at least one intermediate mirror. The scanner also includes a sensor that directly detects the light reflected by the second mirror, wherein the second mirror causes essentially no refraction of the light.

### FIELD OF THE INVENTION

The present invention relates generally to image processing and, more particularly, to a system and method for reading color images with reduced aberration.

### BACKGROUND OF THE INVENTION

Conventionally, a read optical system such as a scanner includes a miniature optical system using a lens. When reading a color image, the R, G, and B light have respectively different refractive indexes. As a result, an image on a CCD that is refracted and focused by the lens generates undesired aberration, which appears on the read image as jitter.

FIG. 1 shows a refractive medium generally illustrating the principle of aberration. As shown in FIG. 1, the refractive medium is a prism 1. When white light 2 enters the prism 1, the light is broken down into its component colors in accordance with the spectral properties of the prism 1. The component colors of the white light 2 have different respective refractive indexes. For example, as shown in FIG. 1, blue light 3 having a comparatively short wavelength among the component colors of the white light has a larger refractive index than that of red light 4, which has a comparatively long wavelength. The different respective refractive indexes cause the path of the blue light 3 and the red light 4 to diverge, with the blue light 3 diverging at a greater angle than the red light 4 from the incident direction of the white light 2.

The same aberration problem illustrated by the prism 1 of FIG. 1 exists in lenses. Conventional scanning systems use lenses to focus scanned images on a reading sensor, such as a CCD. FIG. 2 shows a diagram of a portion of an optical arrangement in a conventional scanning system. As shown in FIG. 2, the white light 2 is incident on a lens 5. The lens 5 is a refractive lens, which creates an effect on the white light 2 similar to the prism 1 of FIG. 1. Like the prism 1, the lens 5 breaks down the incident white light 2 into its component colors, and bends the resulting component colors in directions different from the incident direction of the white light 2, based on their respective refractive indexes.

As shown in FIG. 2, the blue light 3 and the red light 4 are bent at slightly different angles, and each is focused on a CCD sensor 6. The blue light 3 hits the CCD sensor 6 on the optical axis 7. However, because of the different angles, the red light hits the CCD sensor 6 at an offset 8 away from the optical axis 7. The offset 8 causes aberration in a color image generated by the CCD sensor 6.

FIG. 3 is an example of the result of reading an image using the optical arrangement of FIG. 2. In this example, the image being read is a four-sided black image 14. When the image 14 is read, aberration is generated, which affects the reading, and therefore reproduction as well, of the image 14. As a result, the color components are not aligned with each other, and an output image 10 includes an unwanted blue portion 11 and an unwanted red portion 13 in addition to the desired black portion 12. The blue portion 11 and the red portion 13 are on opposing sides of the black portion 12. The output image 10 can appear on, for example, a CRT, a liquid crystal display, or a printed image. Although the image 14 read using the optical arrangement of FIG. 2 is only a black image, the color aberration causes the output image 10 to be a color image.

The color aberration is shown more particularly in FIG. 3 by the various color components. As shown in FIG. 3, after passing through the lens 5, the blue component 15 and the red component 17 are shifted from a proper alignment with the optical axis 7, although the green component 16 is not. These shifts cause a blue-green aberration 18, a red-green aberration 19 and a blue-red aberration 20.

It would therefore be desirable to have an optical system that does not introduce aberration into the read color image.

### SUMMARY OF THE INVENTION

Briefly, in one aspect of the invention, a scanner includes a light source that scans light on a surface to be read, and an optical system that reflects the light scanned on the surface. The optical system includes a first mirror that reflects the light reflected from the surface, at least one intermediate mirror that reflects the light reflected by the first mirror, and a second mirror that reflects the light reflected by the at least one intermediate mirror. The scanner also includes a sensor that directly detects the light reflected by the second mirror, wherein the second mirror causes essentially no refraction of the light.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 shows a refractive medium illustrating the principle of aberration.

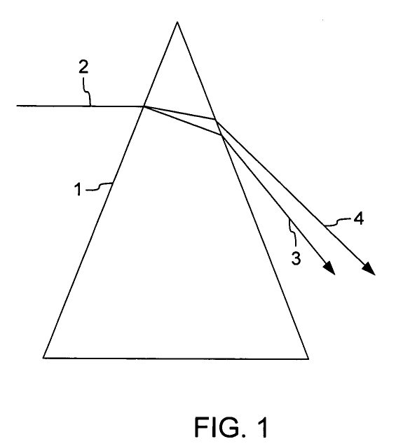

FIG. 2 shows a diagram of a portion of an optical arrangement in a conventional scanning system.

FIG. 3 is an example of the result of reading an image using the optical arrangement of FIG. 2.

FIG. 4 is a block diagram of an optical scanning system consistent with an embodiment of the present invention.

FIG. 5 is a diagram of a portion of the optical scanning system of FIG. 4.

FIG. 6 illustrates an image read using the optical scanning system of FIG. 4.

### DETAILED DESCRIPTION OF THE PREFERRED EMBODIMENTS OF THE INVENTION

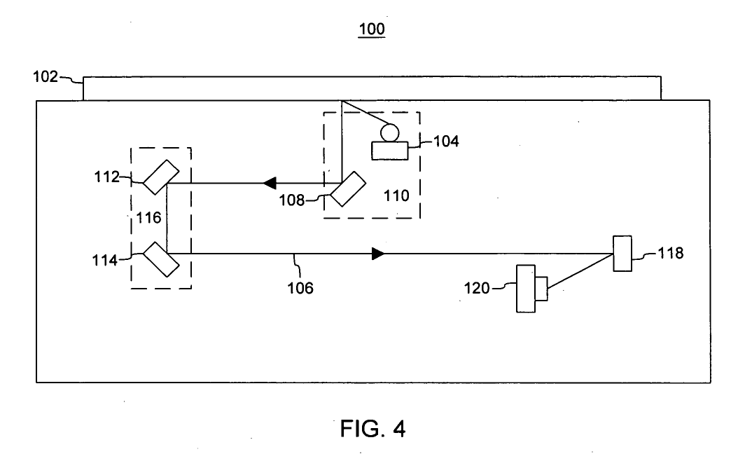

FIG. 4 is a block diagram of an optical scanning system consistent with the present invention. As shown in FIG. 4, a scanning system 100 includes a document table 102, a carriage 110, a carriage 116, a reflecting mirror 118 and a sensor 120. The carriage 110 includes a light source such as a lamp 104 and a reflecting mirror 108. The carriage 116 includes reflecting mirrors 112, 114.

In operation, the lamp 104 scans a light on a document or other original image present on the document table 102. Light 106 reflected from the document is reflected by the reflecting mirror 108. The light 106 reflected by reflecting mirror 108 is then further reflected by the reflecting mirrors 112, 114, respectively. The light 106 reflected by reflecting mirror 114 is then reflected by reflecting mirror 118 onto sensor 120. Other configurations and arrangements of the reflecting mirrors and carriages may also be used.

The sensor 120, which may be implemented as a CCD and CCD substrate, is a line sensor for reading a main scanning direction of a document on the document table 102 as one line via the reflecting mirrors 108, 112, 114 and 118. The brightness and darkness of reflected light from the document may be photoelectrically converted by the sensor 120 and binarized by a binary circuit in the sensor 120. While scanning the document present on the document table 102, the carriages 110 and 116 are driven by a motor (or motors), which moves the reflecting mirrors 110, 112 and 114, as well as the lamp 104. The movement of the carriages 110 and 116 is preferably in the sub-scanning direction to read the overall document.

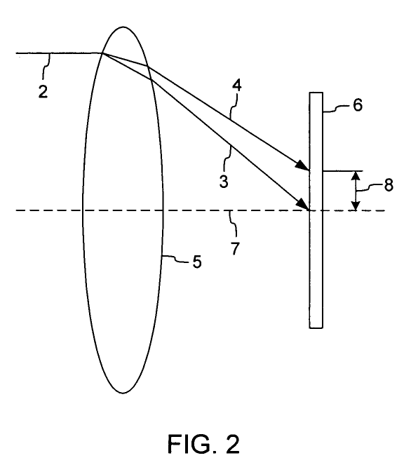

Reflecting mirrors 108, 112 and 114 are all preferably flat reflecting mirrors. Reflecting mirrors 108, 112, and 114 can also be implemented as fresnel mirrors or lenses. Although shown to include three total mirrors, it is possible for the carriages 110 and 116 to support and move more than the reflecting mirrors 108, 112 and 114 that are shown in FIG. 2, or only one reflecting mirror each. Reflecting mirror 118 is preferably a concave reflecting mirror or equivalent structure which can direct the light 106 to the sensor 120 without refracting the light 106. Reflecting mirror 118 can also be implemented as a fresnel mirror or lens. The optical system for directing the light 106 to the sensor 120 preferably excludes any refracting element, such as a refracting lens or prism.

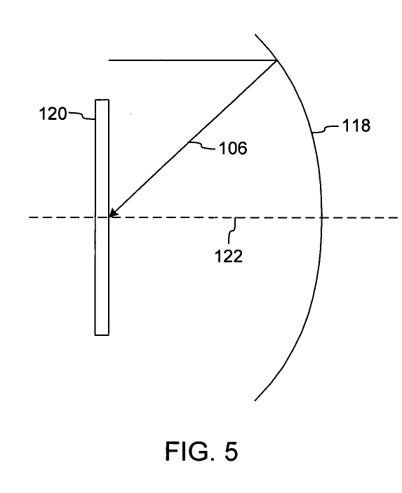

FIG. 5 is a diagram of a portion of the optical scanning system of FIG. 4. As shown in FIG. 5, the reflecting mirror 118 is implemented as a concave reflecting mirror. The light 106 is incident on the surface of the reflecting mirror 118 and is reflected and redirected to the sensor 120 along the optical axis 122. In this embodiment, by limiting the path of the light 106 to reflecting elements only, it is possible to provide the light 106 to the sensor 120 without any aberration generated as the red light, green light and blue light all coincide with each other. As described above, the inclusion of refractive elements, such as a lens or prism, in the path of the light 106 induces the generation of aberration, which negatively affects the output image.

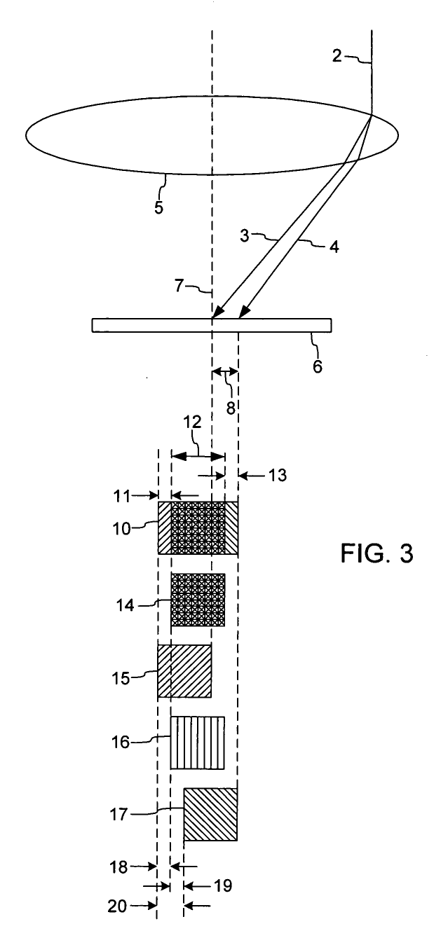

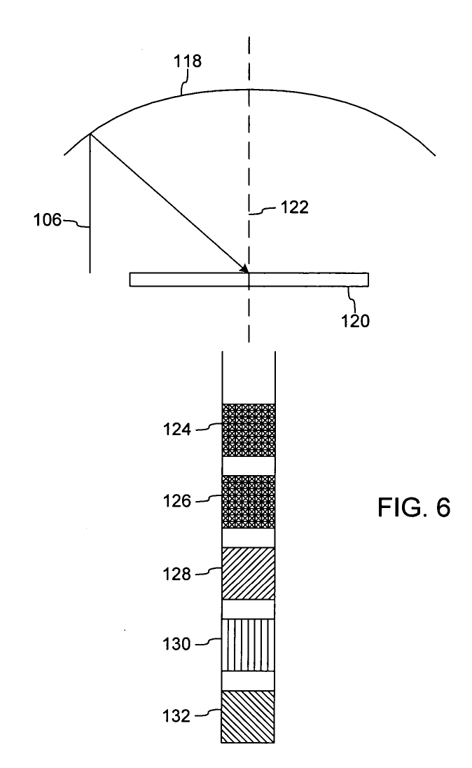

FIG. 6 illustrates an image read using the optical scanning system of FIG. 4. As with the system of FIG. 3, the image being read is a four-sided black image 126. When reading the image 126, the reflecting mirror 118 does not generate any aberration. As a result, an output image 124 is reproduced as the same black image as image 126, without any unwanted blue or red portion. As also shown in FIG. 6, without aberration, a blue component 128, a green component 130 and a red component 132 are aligned with each other along the optical axis 122.

Using a scanning system as shown in FIG. 4, it is possible to scan a document or original image, and provide the scanned image to a sensor, such as a CCD, without generating unwanted color aberration. The optical system can prevent the generation of any color aberration by avoiding using refractive optical elements, such as a lenses or prisms, which are prone to generate color aberration. In place of a lens or prism, the scanning system may use an appropriate reflecting element, such as a concave reflecting mirror or a fresnel mirror, which causes essentially no refraction, or zero refraction of light.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

1. A scanner, comprising:
a light source that scans light on a surface to be read;
an optical system that reflects the light scanned on the surface, comprising:
a first mirror that reflects the light reflected from the surface,
at least one intermediate mirror that reflects the light reflected by the first mirror, and
a second mirror that reflects the light reflected by the at least one intermediate mirror; and
a sensor that directly detects the light reflected by the second mirror,
wherein the second mirror causes essentially no refraction of the light.

2. The scanner according to claim 1, wherein the second mirror is a concave reflecting mirror.

3. The scanner according to claim 2, wherein the first mirror and the at least one intermediate mirror are each flat reflective mirrors.

4. The scanner according to claim 3, wherein the first, intermediate, and second mirrors cause essentially no refraction of light.

5. The scanner according to claim 1, wherein the optical system excludes any refractive mirrors.

6. The scanner according to claim 1, further comprising:
a first carriage supporting the lamp and the first mirror; and
a second carriage supporting the at least one intermediate mirror.

7. The scanner according to claim 6, further comprising a motor that controls a movement of the first carriage and the second carriage when the light source scans light on the surface.

8. The scanner according to claim 7, wherein the motor controls movement of the first carriage and the second carriage in a sub-scanning direction when the light source scans light on the surface.

9. The scanner according to claim 1, wherein the sensor is a CCD.

10. The scanner according to claim 9, wherein the CCD is configured to detect and form a color image from the light reflected by the second mirror.

11. An image forming apparatus, comprising
a document table for supporting a document to be read; and
a scanner, the scanner comprising:
a light source that scans light on the document;
an optical system that reflects the light scanned on the document, comprising:
a first mirror that reflects the light reflected from the document,
at least one intermediate mirror that reflects the light reflected by the first mirror, and
a second mirror that reflects the light reflected by the at least one intermediate mirror; and
a sensor that directly detects the light reflected by the second mirror,
wherein the second mirror causes essentially no refraction of the light.

12. A method for reading a color image, comprising:
scanning a light on a surface;
reflecting the light reflected off of the surface with a first mirror,
reflecting the light reflected by the first mirror with at least one intermediate mirror;
reflecting the light reflected by the at least one intermediate mirror with a second mirror that causes essentially no refraction of light; and
directly detecting the light reflected by the second mirror with a sensor.

13. The method according to claim 12, wherein the second mirror is a concave mirror.

14. The method according to claim 13, the first mirror and the at least one intermediate mirror are each flat reflective mirrors.

15. The method according to claim 14, wherein the first, intermediate, and second mirrors cause essentially no refraction of light.

16. The method according to claim 12, wherein the reflecting includes reflecting the light reflected off of the surface without any refractive member.

17. The method according to claim 12, further comprising moving the first mirror and the at least one intermediate mirror during the scanning of the surface.

18. The method according to claim 17, wherein the first mirror and the at least one intermediate mirror are moved in a sub-scanning direction.

19. The method according to claim 12, wherein the sensor is a CCD.

20. The method according to claim 17, further comprising forming a color image from the light reflected by the second mirror with the CCD.
